(19) United States
(12) Patent Application Publication
(10) Pub. No.: US 2002/0188534 A1
(43) Pub. Date: Dec. 12, 2002

(54) Method and apparatus to establish the value of an activity based on the context of other activities presented in a session

(75) Inventor: James T. Brady, San Jose, CA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: FORECOURT COMMUNICATION GROUP

(21) Appl. No.: 10/156,343

(22) Filed: May 28, 2002

Related U.S. Application Data
(60) Provisional application No. 60/296,703, filed on Jun. 7, 2001.

(51) Int. Cl. G06F 17/60

(52) U.S. Cl. 705/32

(57) ABSTRACT

A system for scheduling activities at a user terminal, normally associated with a point-of-service station, such that the activity selected is based on the prior history of activities presented to the user and their effect on the expected value of the candidate activities.

### FIELD OF THE INVENTION

This invention relates to selecting activities to be presented to a user of a terminal, where the activities are selected by a system based on the potential value of the activities to the stakeholders of the system. The terminals are frequently found associated with point-of-service stations like gas dispensers in gas stations, check out counters in grocery venues, pharmacies, and other retail venues, ATMs, and other point-of-service terminals.

### BACKGROUND OF THE INVENTION

Recent additions to the capability of point-of-service terminals have enabled the presentation of visual and/or audio materials to the user and permit the user to interact with the systems supporting said point-of-service terminal. This has opened up the opportunity to present activities to the user, which are not directly related to the primary purpose of the point-of-service terminal.

These presentations occur during the final minutes of a purchase of products in a retail environment, when the user is idle (idle time). In a multilane venue, (grocery, variety goods, etc.) the user waits for the checkout clerk to ring up the purchases. In a gas station, the user waits for the attendant or pump to fill the tank. This is wasted time. The wasted time is called “idle time”. In general, neither the user nor the venue benefits from the activities of the user during this time. Systems have been built to present activities as describe above, to users during the wasted time. Such as system is described in docket 09/497,744.

The systems described thus far (ref. Optima Fit—867.0006USU), the user is presented with activities based on a value that is assigned independently to each activity. This allows the presentation of activities that conflict with prior activities presented to the user. An example of such a conflict would be the offer to sell a hamburger to the user right after the user has completed another activity that was offering to purchase a taco. While there is some probability the user would purchase both, it is more likely that once the taco is purchased, the probable value of an offer to sell a hamburger is substantially reduced over what it would have been if the user had rejected the taco offer.

### SUMMARY OF THE INVENTION

It is an object of this invention to determine the probable value of an activity that is a candidate for presentation to a user, based on the prior activities presented to the user.

It is another object of this invention to determine the probable value of an activity that is a candidate for presentation to a user, based on the order of prior activities presented to the user.

It is another object of this invention to determine the probable value of an activity that is a candidate for presentation to a user, based on the outcome of prior activities presented to the user.

The invention is system in the form of programming instructions and computing equipment embodied in a venue server that provides activities to a user terminal that is frequently co-located with a point-of-service terminal. This system provides for: definition of activities and their characteristics, logging of activities and their outcomes, definition of a conflict measurement system, and means to revalue activities using the conflict measures.

When the system is running, a control mechanism contained in the invention, calculates the expected value of running a specific activity. That calculation includes the erosion of value due to running other activities prior to the activity under examination. The expected value can then be used by the system for making the decision to present the activity.

In some embodiments, multiple activities would be considered by the control mechanism, and the one with the highest value would be chosen for presentation.

### BRIEF DESCRIPTION OF THE DRAWINGS

FIG. 1 is the Overview of the invention.

FIG. 2 is a diagram of a computer system called the Central Server.

FIG. 3 is a diagram of a computer system called the Venue Server.

FIG. 4 is a diagram of a User Interface.

FIG. 5 is the Activity Table.

FIG. 6 Activity List

FIG. 7 Activity and Ordinal List

FIG. 8 is a Venue Table.

FIG. 9 Activity Attribute Table

FIG. 10 Attribute Table

FIG. 11 Session Table

FIG. 12 Activity Log

FIG. 13 Attribute Summary Table

FIG. 14 Normalized Attribute Summary Table

FIG. 15 Attribute Probability Matrix

FIG. 16 Probability Matrix Entry

FIG. 17 Attribute Rule Matrix

FIG. 18 Influence Decay

FIG. 19 Activity Correlation Matrix

FIG. 20 Update Parameters

FIG. 21 Activity Selection

### DETAILED DESCRIPTION OF THE INVENTION

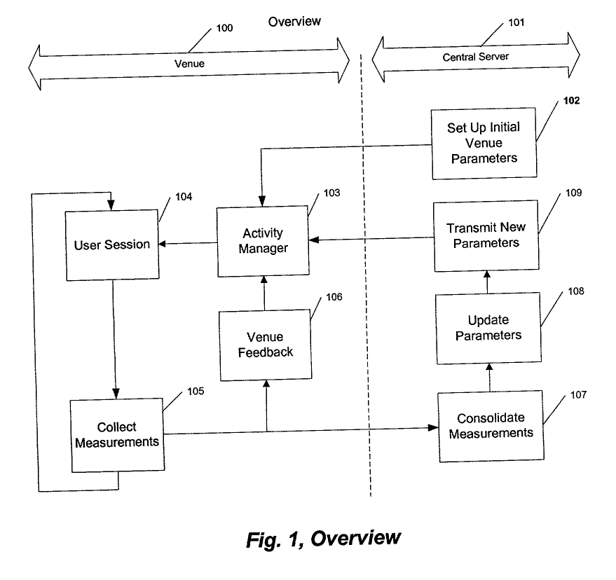

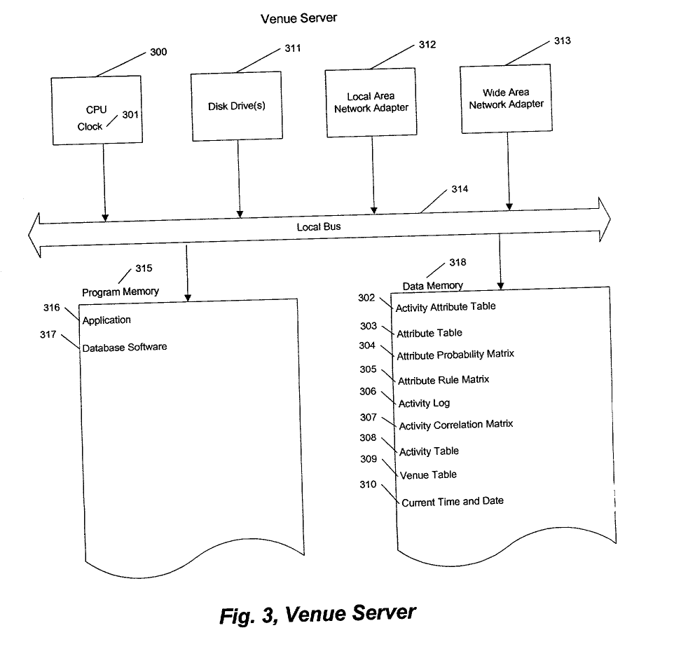

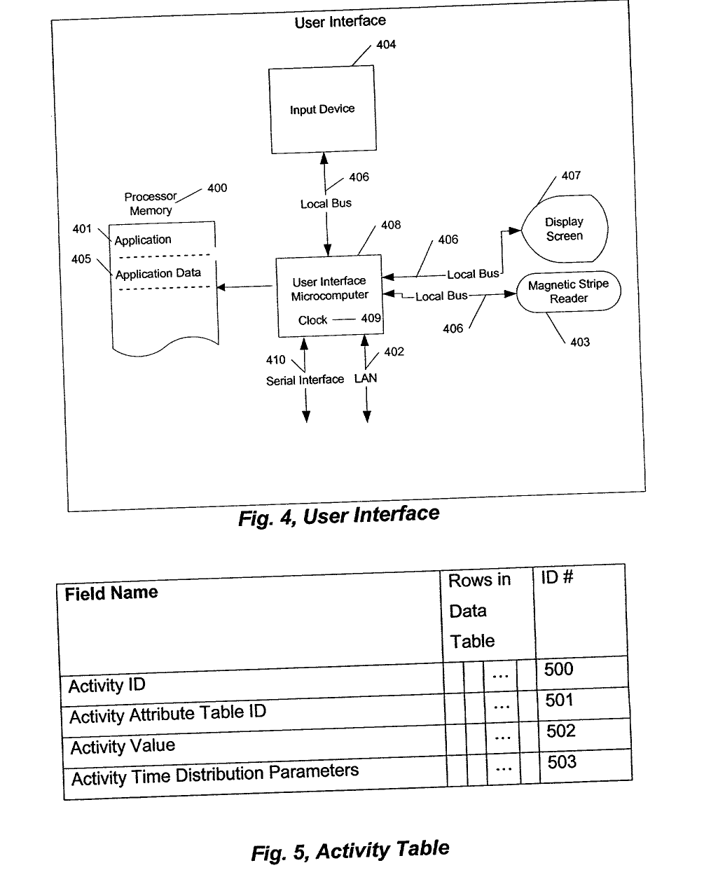

FIG. 1 Overview is a high level view of the process incorporating the invention. The process is spread across two locations in this embodiment. Central Server 101 performs data entry functions to set up parameters for Venue 100, to consolidate measurements in the form of FIG. 12 Activity Log, analyze the measurements in the context of the parameters, and to initialize and update the parameters it has down loaded into the Venue 100. The Venue 100 manages the presentation of various activities to the user of terminal located at the venue. That terminal is described in FIG. 4 User Interface. Activities are presentations and interactions with the user of the FIG. 4 User Interface. Activities may be as simple as the presentation of information that does not require action on the part of the user (advertisements, lost child alerts, today's weather forecast . . . ), or more complex interactions requiring decisions on the part of the user (coupon offers, offers to sell a product, offers to sell a service, requests for map directions, downloads of videos . . . ). This management function is housed in the FIG. 3 Venue Server.

When a Venue 100 is initially defined to the Central Server 101, the process Set Up Initial Venue Parameters 102 develops a set of table to send to the Venue 100, to set up activities and users in the venue. These are base on information received as part of the data entry of the definition of users, venues, and activities, and the prior experience with similar users, venues and activities. These are transmitted to Activity Manager 103 in Venue 100. When a user goes into session with the system, User Session 104 presents activities selected by Activity Manager 103 for that user. The objective of Activity Manager 103 is to select activities based on what has happened within the session to the point it is selecting the next activity for presentation.

When User Session 104 has completed an activity, Collect Measurements 105 captures information about that activity and sends it to Venue Feedback 106 and Consolidate Measurements 107. Venue Feedback 106 updates the tables the Activity Manager 103 uses, so it can use that information in the selection of the next activity in the session.

Consolidate Measurements 107 collects information from one or more Venues 100 and stores them in a database. Periodically, Update Parameters 108 function is triggered, and new parameters are generated, if the data warrants. These are then forwarded to Transmit New Parameters 109 for loading Venue 100's, Activity Manager 103.

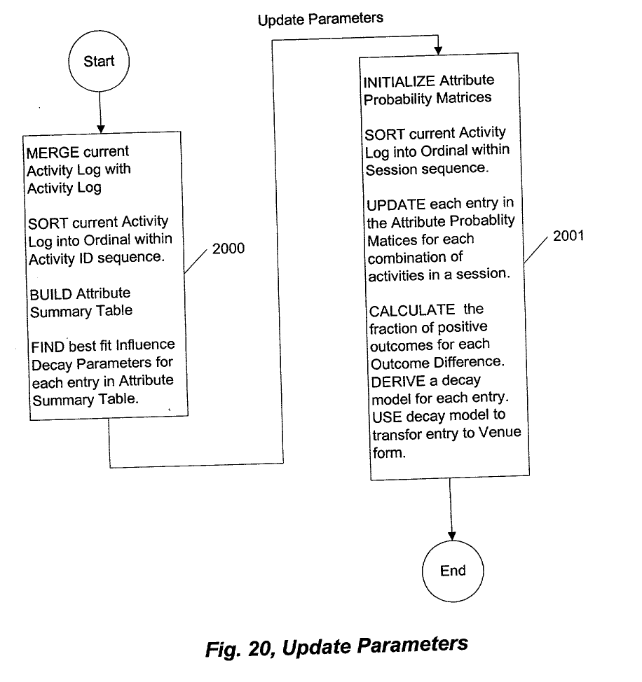

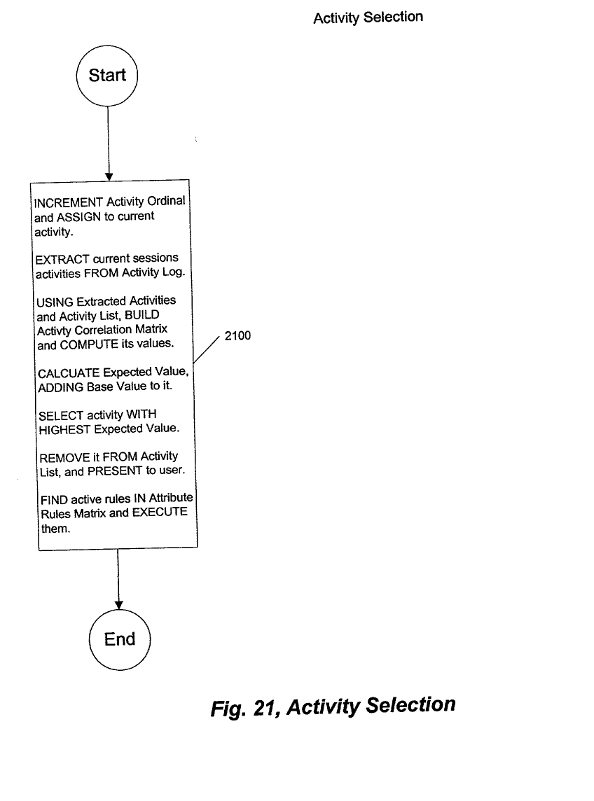

The key processes of the invention are embodied in Activity Manager 103 and Update Parameters 108. Activity Manger 103's, function is describe in FIG. 21, Activity Selection, and Update Parameters 108 is described in FIG. 20, Update Parameters.

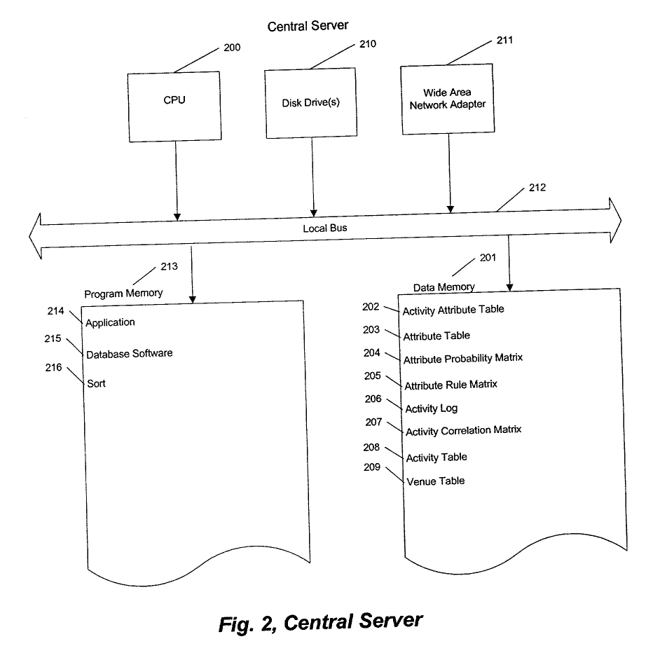

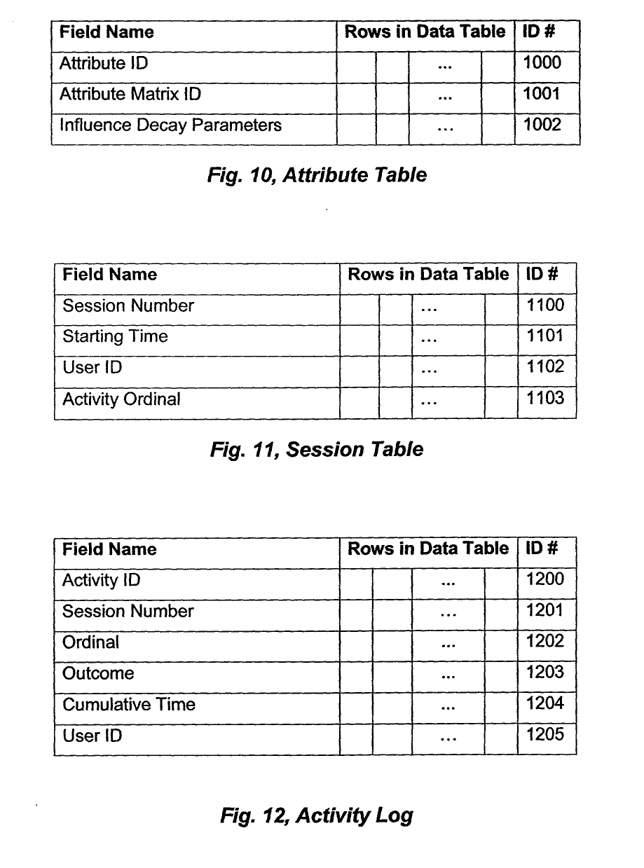

FIG. 2 Illustrates further details of Central Server, which performs the functions of collecting presenter data and venue data using conventional data entry mechanisms, and analyzing the Activity Log 206 to produce Activity Attribute Table 202, Attribute Table 203, Attribute Probability Matrix 204, Attribute Rule Matrix 205, Activity Correlation Matrix 207, Activity Table 208, and Venue Table 209. CPU 200 is a conventional microprocessor with a Local Bus 212 that connects it to Disk Drive(s) 210, a Wide Area Network Adapter 211, a Program Memory 213, and a Data Memory 201. Program Memory 213 contains Application 214 that: collects Activity Log 206, stored in FIG. 3 Venue Server by way of Wide Area Network Adapter 211, using standard communication protocols such as TCP/IP; collects the information, to build FIG. 5 Activity Table, FIG. 8 Venue Table, FIG. 9 Activity Attribute Table, FIG. 10 Attribute Table, and FIG. 17, Attribute Rule Matrix, using conventional data entry mechanisms; and builds the Attribute Probability Matrix 204 and determines the Influence Decay Parameters 1002. This information is stored using Database Software 215 into Data Memory 201 and subsequently onto Disk Drive(s) 210. Sort 216 is used to order data under the control of Application 214. FIG. 8, Venue Table is sent to the FIG. 3 Venue Server, specified in the Venue ID 800.

FIG. 3, Venue Server, is a representation of a Venue Server. Venue Server is described as though it is implemented as a separate computer system, however the function provided can be performed in other computer systems supporting the venue. Activity Attribute Table 302, Attribute Table 303, Attribute Probability Matrix 304, Attribute Rule Matrix 305, Activity Correlation Matrix 307, Activity Table 308, and Venue Table 309, are downloaded from FIG. 2, Central Server, from its corresponding tables. Activity Log 306 is constructed by Application 316 by copying Activity ID 500 of the selected activity into Activity ID 1200, setting Ordinal 1202 to the position of the activity in the sequence of activities presented in the user's session, recording the Outcome 1203 of the activity when the activity completes, and recording the Cumulative Time 1204 of the session when the activity completes. FIG. 3, Venue Server, communicates with FIG. 2, Central Server, via Wide Area Network Adapter 313 to acquire the information and store it in Data Memory 318 and on Disk Drive(s) 311. Internally the various components communicate via Local Bus 314 The tables acquired are Activity Attribute Table 202, Attribute Table 203, Attribute Probability Matrix 204, Attribute Rule Matrix 205, Activity Correlation Matrix 207, Activity Table 208, and Venue Table 209 Application 316, in Program Memory 315, makes use of commercially available Database Software 317 to the provide storage, selection and retrieval functions that it needs.

Data Memory 318 also contains Current Time and Date 310 provided from Clock 301 in CPU 300, which is used to time stamp the entries in FIG. 12, Activity Log.

Venue Server also communicates via Local Area Network Adapter 312, to FIG. 4, User Interface.

FIG. 4 is a diagram of User Interface. It has a User Interface Microcomputer 408 that is attached via a LAN 402 and/or Serial Interface 410 to FIG. 3, Venue Server, and is attached via LAN 402. User Interface Microcomputer 408 contains a Clock 409 that provides time in a form that includes the Month, Day-of-week, Hour, Minute, And Seconds. User Interface has a Display Screen 407, which can display textual and (optionally) graphical information to the user. Magnetic Stripe Reader 403 is provided to allow the input of user identification information from a variety of identification cards. Input Device 404 (like a keypad or touch screen) is used to allow the user to manually input information. Input Device 404 is typically a keypad or a touch screen. As User Interface Microcomputer 408 is programmable, it is capable of performing the various functions described elsewhere. The elements of FIG. 4, User Interface, are connected by a Local Bus 406. As implementations vary from manufacturer to manufacturer, more than one Local Bus 406 may be used. Processor Memory 400 contains Application 401 and Application Data 405 need to run the User Interface. Application 401 presents the activities to the user and receives the responses from the user, forwarding them to FIG. 3, Venue Server.

FIG. 5 is the Activity Table, which are the candidate activities to be presented to a user. Activity ID 500 is a unique identifier assigned by Application 214 to each activity, as it is entered into the FIG. 2, Central Server. Activity Attribute Table ID 501 is the identifier for the entry in FIG. 9, Activity Attribute Table that contains the Attribute IDs 1000, specifying the FIG. 10, Attribute Table entries associated with the activity. Activity Value 502 is the value for successful completion of the activity, from the perspective of the entity receiving revenue for presenting the activity. Activity Time Distribution Parameters 503 describe the probability distribution for the time it takes to present an activity.

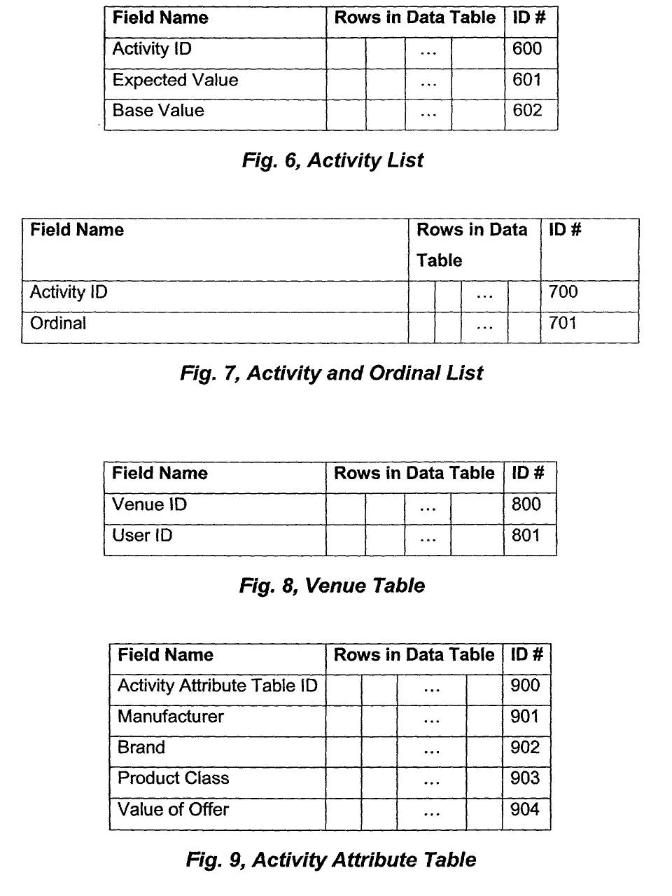

FIG. 6 is a representation of an Activity List. An Activity List is constructed at the start of each user session by copying the Activity ID 500 from each entry in FIG. 5, Activity Table. It is composed of: Activity ID 600 which is copied from Activity ID 500, Expected Value 601 which is the probable value of this activity when presented in the context of the session and is calculated as described in FIG. 21, Activity Selection, and Base Value 602 which may be set by rule in FIG. 17, Attribute Rule Matrix. Base Value 602 added to the final Expected Value 601 to determine the likely value of presenting Activity ID 600.

During the session, as an activity is presented, its Activity ID 600 is deleted from FIG. 6, Activity List. Activities are selected for presentation to a user from this list as described in FIG. 21, Activity Selection. When an activity is presented, it is deleted from the list and the FIG. 17, Attribute Rule Matrix rules for manufacturers and brands are run. These rules may delete entries in the FIG. 6, Activity List, change Expected Value 601,

FIG. 7 is a representation of an Activity and Ordinal List, comprised of: Activity ID 700 that is copied from Activity ID 1200 when the list is constructed. Ordinal 701 is copied from Ordinal 1202 from the same entry in FIG. 12, Activity Log. The list is used as the source of activities that have been presented in a session. The list is only active during a session and is specific to that session.

FIG. 8 is the Venue Table composed of Venue ID 800, and User ID 801. The Venue ID 800 is a unique identifier that is assigned by Application 214 when a new venue is loaded into the system. User ID 801 is the identifier used by the user during interactions with the FIG. 4 User Interface. If the user did not use a standard identification (Credit Card, Debit Card, Loyalty Card . . . ) a User ID 801 value reserved for anonymous users is assigned.

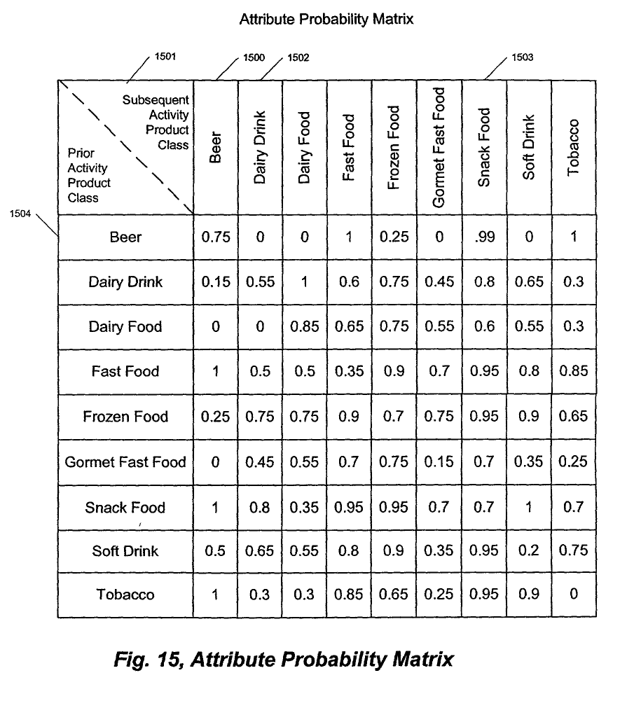

FIG. 9 is a representation of an Activity Attribute Table, composed of Activity Attribute Table ID 900, Manufacturer 901, Brand 902, Product Class 903, and Value of Offer 904. The attributes (callouts 901 through 904) shown are illustrative of attributes having impact on a subsequent activity, or being impacted by a previous activity. The attributes are not static, but periodically selected, based on the history of the system. That mechanism uses conventional transaction logging and statistical correlation techniques that are well know to those familiar with the state of the art. Each Activity in FIG. 5 Activity Table has an entry in FIG. 9 Activity Attribute Table, who's Activity Attribute Table ID 900 contains the same value as Activity Attribute Table ID 501. The value in each attribute field (callouts 901 through 904) is the value from one Attribute ID 1000, providing a linkage to the FIG. 10, Attribute Table. Manufacturer 901 and Brand 902 use FIG. 17, Attribute Rule Matrix, and Product Class 903 and Value of Offer 904 use FIG. 15, Attribute Probability Matrix. Value of Offer 904, attribute uses ranges of values as its classes in the FIG. 15, Attribute Probability Matrix, in place of the Product Classes shown in the diagram.

FIG. 10 is a representation of an Attribute Table, comprised of Attribute ID 1000, which uniquely identifies the attribute; Attribute Matrix ID 1001 that identifies FIG. 17, Attribute Rule Matrix, or FIG. 15, Attribute Probability Matrix, associated with the attribute. The types are: “Probability” (as in FIG. 15, Attribute Probability Matrix), and “Rule” (as in FIG. 17, Attribute Rule Matrix). Influence Decay Parameters 1002 are the values for the decay equation that describe the falloff in value for the attribute as a function of the other activities presented before it in the user's session.

FIG. 11 is a representation of a Session Table, composed of: Session Number 1100 which is assigned by Application 316 at the start of a session and is used to set Session Number 1201 each time a Activity is presented to the user during the session, Starting Time 1101 is the time-of-day accessed Current Time and Date 310 at the start of the session, User ID 1102 is a unique ID for a user or a non-unique ID used to specify an anonymous user and it set at the start of the session, and Activity Ordinal 1103 is the position of the activity in the session. Activity Ordinal 1103 is initialized to zero at the start of the session and incremented by one each time a new activity is performed. It is used to set Ordinal 1202.

FIG. 12 is a representation of an Activity Log, which is constructed each time a user session is started. It is composed of Activity ID 1200, Session Number 1201, Ordinal 1202, Outcome 1203, and Cumulative Time 1204. Activity ID 1200 is the Activity ID 500 of the activity presented to the user. Session Number 1201 is a unique number assigned by Application 316 at the start of each user session. Ordinal 1202 is the position of the activity in the sequence of activities. Outcome 1203 indicates the result of the activity. This may indicate the activity was not completed by the user, or which outcome the user selected. Cumulative Time 1204 is the amount of time from the start of the user session to the end of this activity. User ID 1205 identifies a unique user of the system or, non-uniquely, an anonymous user. This field is used if user specific FIG. 15, Attribute Probability Matrix, or FIG. 17, Attribute Rule Matrix are desired. FIG. 12, Activity Log, is build in FIG. 20, Update Parameters and used in FIG. 21, Activity Selection.

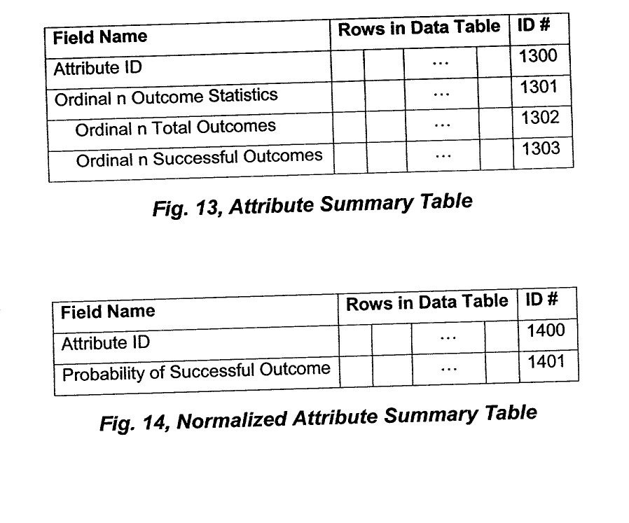

FIG. 13 is a representation of an Attribute Summary Table. It is composed of an Attribute ID 1300 that is used to relate each entry with the corresponding entry in the FIG. 10, Attribute table, and the repeated field Ordinal n Outcome Statistics 1301, composed of Ordinal n Total Outcomes 1302, and Ordinal n Successful Outcomes 1303. Where the number of repetitions of Ordinal n Outcome Statistics 1301 is set to encompass the maximum number of activities presented in a session, or a value that excludes ordinals having a low percent successful outcome for those ordinals. These values are accumulated in Step 2000 of FIG. 20, Update Parameters.

FIG. 14 is a representation of a Normalized Attribute Summary Table. It is composed of Attribute ID 1400, which is extracted from Attribute ID 1300 when the table is built; and Probability of Successful Outcome 1401 is calculated from Ordinal n Outcome Statistics 1301, by back calculation of each set of statistics, using the Influence Decay Parameters 1002, as though they were in the first activity presented in a user session (see FIG. 20, Update Parameters).

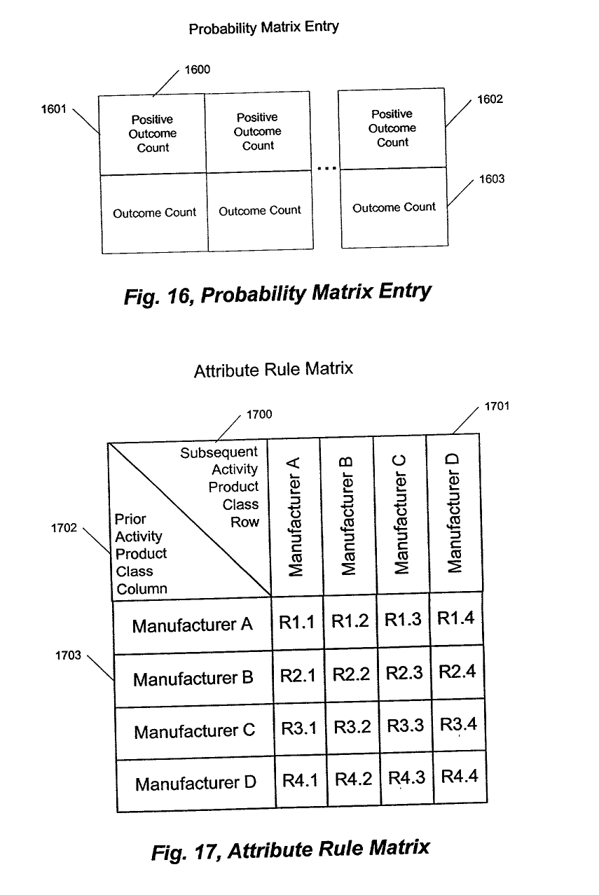

FIG. 15 is a representation of Attribute Probability Matrix. There is one matrix for Product Class 903 and Value of Offer 904. The entries in the body of the matrix take on one of two forms. FIG. 16, Probability Matrix Entry, shows the form used in Central Server 101 to develop the second form used in Venue 100. The second form is described as follows: For exemplary purposes, Beer 1504 will be used to describe the functioning of the matrix. As each Product Class appears twice in the matrix, Beer 1500 is used as well. It indicates the column to be evaluated when Beer is considered for presentation after another activity or activities. When Beer 1504 is presented prior to Dairy Drink 1502, the probability of a positive outcome for an Activity presenting Dairy Drinks is zero. This indicates that the probability the same user will respond to an activity featuring Dairy Drinks is low. On the other had if the activity contained Snack Food, then the intersection of Beer 1504 and Snack Food 1503 would yield a probability of one, indicating that this would be a good choice as the next activity. The number of entries in each matrix is determined by statistical analysis of the history of the system. A figure of merit is calculated by finding the average and standard deviation of each row and corresponding column (say, Beer 1504 and Beer 1500) and summing the four numbers. The entry's figure of merit is compared to a criterion value to select the entries. Other ways to compute a figure of merit are obvious to one familiar with the state-of-the-art.

FIG. 16 is a representation of a Probability Matrix Entry, it is composed of a two dimensional array. The Columns 1600 entries are for each unique Ordinal Difference value, which is the difference of the Ordinal 1202 for two activities presented in the same session specified by Session Number 1201. The entries in the Rows 1601 are: Positive Outcome Count 1602 giving the count of the outcomes that were positive, and Outcome Count 1603 is the count of all outcomes, positive or negative.

FIG. 17 is a representation of an Attribute Rule Matrix. The matrix is composed of Prior Activity Product Class Column 1702, which contains one entry for each entity in that activity attribute; and Subsequent Activity Product Class Row 1700, which also contains one entry for each entity having that activity attribute. The entry at the intersection of two entities, say Manufacturer B 1703 and Manufacturer D 1701, contains rule R2.4, in the form of a rules based language like Regular Expressions. (Information of Regular Expressions can be found at and in “Mastering Regular Expressions: Powerful Techniques for Perl and Other Tools”, Jeffrey E. Friedl, January 1997, O'Reilly Nutshell.) Say, Manufacturer B 1703 contains a value “D” and Manufacturer D 1701 contains a value “B”, and are competitors. Manufacturer D has specified it does not want its activities presented after Manufacturer B's activities. The rule R2.4 would test this condition and if met would remove Manufacturer D's activities from consideration as a potential for presentation to the current user. The Attribute Rule Matrices are built from rules provided by the manufacturer or the manufacturer's brand manager. Each entry may be a simple rule or a collection of rules.

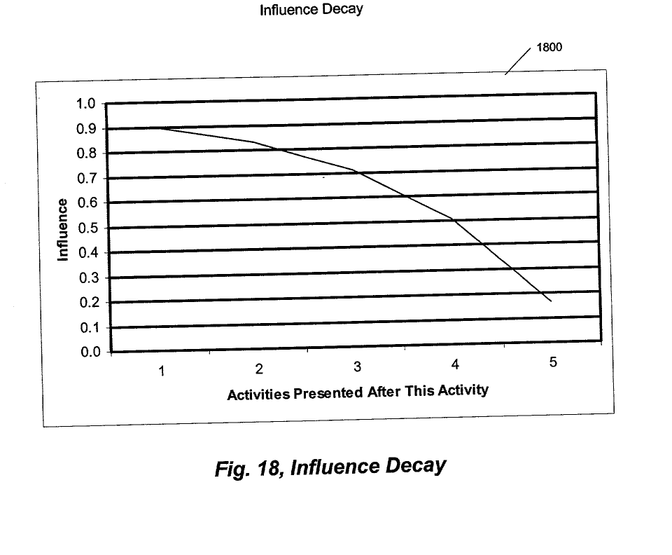

FIG. 18 is a representation of Influence Decay. In Influence Decay Chart 1800 the decay model is:

Iₙ=1-(I*(i+d)⁽ⁿ⁻¹⁾,

where

Iₙ is the influence of the activity after n subsequent activities have been presented,

i is the initial decay parameter, and

D is the decay rate parameter.

The decay parameters are stored in Influence Decay Parameters 1002 and are used in FIG. 18, Activity Selection.

The chart is exemplary of the numerous decay equations that can model the influence decay.

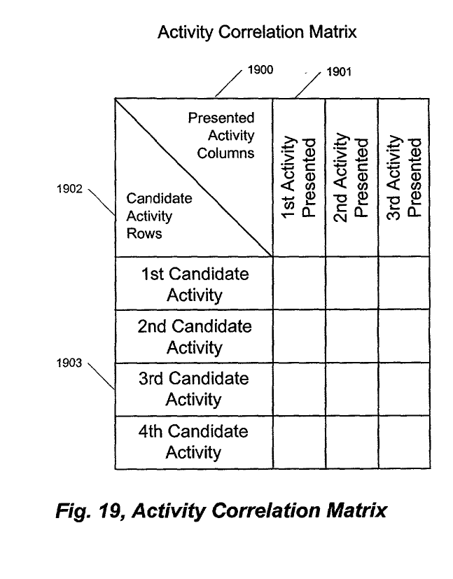

FIG. 19 is a representation of an Activity Correlation Matrix. The matrix is composed of Candidate Activity Rows 1902, which contains one entry for candidate activity; and Presented Activity Columns 1900, which contains one entry for each activity previously presented in the current session with the user. The intersection of two activities, say 3^{rd} Candidate Activity 1903 and 1^{st} Activity Presented 1901, contains a probability that the 3^{rd} Candidate Activity 1903, will have a successful outcome, given that 1^{st} Activity Presented 1901, preceded it.

FIG. 20 is a flow diagram of the Update Parameters routine. Step 2000 sorts the FIG. 12, Activity Log, into Ordinal 1202 within Activity ID 1200 sequence. It then processes each element of the FIG. 12, Activity Log by locating the FIG. 5, Activity Table entry with the same Activity ID 500 value as Activity ID 1200. Then Activity Attribute Table ID 501 is used to locate the corresponding entry in FIG. 7, Activity Attribute Table. The Attribute IDs in that entry's Manufacturer 901, Brand 902, Product Class 903, and Value of Offer 904 fields, are successive used to locate entries in the FIG. 13, Attribute Summary Table to update Ordinal n Outcome Statistics 1301, where n corresponds to Ordinal 1202. Ordinal n Total Outcomes 1302 is incremented by one for the entry where n is equal to Ordinal 1202. The corresponding Ordinal n Successful Outcomes is incremented when Outcome 1203 is a positive outcome. When the FIG. 12, Activity Log, has been completely processed, each element of FIG. 13, Attribute Summary Table is processed, generating Influence Decay Parameters 1002 for each Attribute ID 1300 in the table. They are calculated by determining the fraction of successful outcomes (Ordinal n Successful Outcomes 1303/Ordinal n Total Outcomes 1302) and using a decay model as in FIG. 18, Influence Decay, and a curve fitting routine like Least Squares Fit to fit the ordinals of each to the fraction of successful outcomes. Control then passes to Step 2001.

Step 2001 Initializes the FIG. 15, Attribute Probability Matrix for Product Class and Value of Offer and then sorts FIG. 12, Activity Log, by Ordinal 1202 within Session Number 1201. It then processes each entry in FIG. 12, Activity Log, in groups having the same value in Session Number 1201. Within these groups let ne=the number of entries and index=the index of the first entry in the group. Let j range from index to ne−1 in increments of one, and k range from j+1 to ne in increments of one. Then for each pair of j and k perform the following: Let Ordinal Difference=k−j. Continue by locating Product Class 903 for entry j and Product Class 903 for entry k, by using Activity ID 1200→Activity ID 500 giving Activity Attribute Table ID 501→Activity Attribute Table ID 900, giving Product Class 903. Using those to determine an entry in FIG. 15, Attribute Probability Matrix for Product Class, where the row is the entry associated with j and the column the entry associated with k. Updating that entry such that: Outcome Count 1603 (Ordinal Difference) is incremented, and if Outcome 1203 (k) is positive, Positive Outcome Count 1602 (Ordinal Difference) is incremented. In the same manner the Value of Offer's, FIG. 15, Attribute Probability Matrix is updated.

Next each FIG. 15, Attribute Probability Matrix's FIG. 16 Probability Matrix Entry is processed as follows: While j ranges from one to number of rows in the entry, calculate the Fraction of Positive Outcomes for each j. Using the collection of Fraction of Positive Outcomes and the decay model described in FIG. 18, Influence Decay, produce a model specific to this entry. Evaluate that model at zero and use the result to transform the form of the entry from Central Server 101 form to Venue 100 form, as describe in FIG. 15, Attribute Probability Matrix.

FIG. 21 is a flow diagram of the Activity Selection. The input to the routine is an entry in FIG. 11, Session Table, and the FIG. 6, Activity List associated with the session. Using that entry, Step 2100 increments Activity Ordinal 1103 and uses Session Number 1100 to access the entries in FIG. 12, Activity Log, with Session Number 1201 having the same value, producing FIG. 7, Activity and Ordinal List by copying Activity ID 1200 to Activity ID 700, and Ordinal 1202 to Ordinal 701. FIG. 19, Activity Correlation Matrix is initialized for the session by producing a row for each entry in FIG. 6, Activity List, and producing a column for each candidate activity in FIG. 7, Activity and Ordinal List. The entries in the matrix are calculated by taking the Activity ID 600 for the row being processed and the Activity ID 700 for the column being processed and using them to access the Product Class 903 and Value of Offer 904 via the FIG. 5, Activity Table's, Activity Attribute Table ID 501. These are used to select an entry in Product Class 1501 in FIG. 15, Attribute Probability Matrix. Call the value of that entry X. Then use Activity ID 700 to locate Influence Decay Parameters 1002. Influence Decay Parameters 1002 are used to evaluate the decay model at the difference between Activity Ordinal 1103 and Ordinal 701. Call the result Y. This is the decay do to the relative position of the prior activity and the candidate activity. Multiply X times Y, subtracting the product from one. Store the difference in the previously selected entry in FIG. 19, Activity Correlation Matrix. When the matrix has been filled, Expected Value 601 is calculated by multiplying Activity Value 502 by one minus the product of all values in the corresponding row of FIG. 19, Activity Correlation Matrix. Then Base Value 602 is added to Expected Value 601. The activity with the highest Expected Value 601 is selected for presentation to the user. The activity is deleted from FIG. 6, Activity List, and the Expected Value 601 and Base Value 602 are reset. Then FIG. 17, Attribute Rule Matrix is examined for applicable rules and they are implemented.

### TYPICAL HARDWARE AND SOFTWARE INFRASTRUCTURE

The system can be implemented on conventional point of sales equipment and personal computers using operating systems like Unix, the various PC operating systems, or the embedded operating systems like Wind Rivers VxWorks™; data base software like Oracle™, IBM's DB2™, or other commercial database, and communications systems like the Internet and its supporting software and protocols. The implementation can be executed in conventional programming languages like C, C++, and Java, to name a few. The rules implementation is facilitated through the use of facilities like regular expression (See: Mastering Regular Expressions: Powerful Techniques for Perl and Other Tools Jeffrey E. F. Friedl, Andy Oram (Editor)/Paperback/O'Reilly & Associates)

1. A system having a list of activities for presenting to one or more users in a venue, having mean for valuing a activity prior to presentation to said user in a venue based on the outcome of prior presentation of other said activities to said user in the same session, the system comprising:
one or more terminals at point-of-service stations, each having means for presenting information to the user and receiving responses from said user;
a venue server with which said terminals can communicate, said venue server having a user database, activity log, and activity database;
said user database having a user identification means, and user profile means;
said activity log containing a record of all said activities presented in said session and order indicia for each said activity;
said activity database having means to identify and define said activities;
said activity database having a means to associate each of said activities with other said activities in the form of a measure of conflict;
means for said venue server to calculating the value of said first activities based on said measure of conflict and said second activities presented in a session.

2. A system as in claim 1, where further means are provided to calculate said value of said activities further based on said order indicia of said activities in said activity log.

3. A system as in claim 1, where further means provide a outcome indicia in said activity log, and to calculate said value of said activities further based on said outcome indicia of said activities in said activity log.

4. A system as in claim 1, where further means provide a list of alternative candidate activities, programming means to evaluate the expected value of each element of said list, and programming means to select said activity having the highest said expected value, from said list.

5. A system as in claim 1, where further means provide one or more attributes for said activities, programming means to find correlations between said attributes, and programming means to select said activities based on said correlation of said activity's said attributes, with said activities', in said activity log, said attributes.

6. A system as in claim 1, where further means provide rules for said activities, programming means to evaluate said rules such that said calculating the value of said activities is modified by the outcome of said evaluation of said rules.

7. A system as in claim 6, where further means provide said rules to delete specific said activities from said list for the rest of said session.

8. A system as in claim 1, where further means are provided to include in said activity log said outcome of prior presentations from prior sessions with said user.
